(19) United States
(12) Patent Application Publication
(10) Pub. No.: US 2011/0228716 A1
(43) Pub. Date: Sep. 22, 2011

(54) METHODS AND SYSTEMS FOR MULTIPLEXING MULTIPLE SERVICE COMPONENTS INTO ONE FLOW IN A FORWARD LINK ONLY NETWORK

(75) Inventors: Qi Xue, San Diego, CA (US); Prasanna Kannan, San Diego, CA (US)

(73) Assignee: QUALCOMM Incorporated, San Diego, CA (US)

(21) Appl. No.: 12/726,088

(22) Filed: Mar. 17, 2010

(51) Int. Cl. H04H 20/71; H04L 12/28

(52) U.S. Cl. 370/312; 370/390

(57) ABSTRACT

Methods and systems for transmitting multiple service components in a single mediaFLO logical channel (MLC) stream within a MediaFLO® broadcast signal to distinguish data packets of different components based upon different media type header information or a component identifier added to the data packet header information. In a first embodiment, multiple service components of different media types are broadcast within the same MLC stream. Mobile device can separate received data packets within the MLC based upon their respective media type header information, and route each pack to its corresponding component processing module. In a second embodiment, different service components are identified with a component identifier that is added to the packet headers. A new layer in the protocol architecture stack can use the component ID within each data packet header to select and properly route the data packets for processing.

### BACKGROUND

Wireless communication technologies have seen explosive growth over the past few years. This growth has been fueled by wireless services providing freedom of movement to the mobile public and cutting the tether to hardwired communication systems. As a result of service enhancements, the popularity of wireless services is expected to continue to grow rapidly. A recent addition to wireless communication services has been the ability to broadcast television and other content to mobile devices. Mobile multimedia broadcast services allow users to view TV programming, as well as receive mobile editions of news, entertainment, sports, business, and other programming, using their cell phone or other wireless mobile device configured to receive the mobile broadcast transmissions. The bandwidth and capabilities of mobile multimedia broadcast technologies is expected to lead to an expanding user base and an expansion of applications and uses for such systems.

### SUMMARY

The various embodiments provide methods and systems for combining and transmitting multiple service components in a single media stream within a MediaFLO® multimedia broadcast system. The embodiments enable a single MediaFLO® mediaFLO logical channel (MLC) with a limited number of media streams to carry more service components and therefore allow the media broadcast system to more efficiently use MLCs. A first embodiment of the invention fits multiple service components into the same media stream by multiplexing packets for transmission. On the receiving end, the mobile device can separate the packets within each media stream and assign them to the different service components based upon the flow ID and routing type assigned to each packet. One advantage of this embodiment is that it may be implemented in the existing protocol stack architecture of MediaFLO by relying on the routing type and flow ID values already in use. However, in this embodiment the mobile device may only differentiate different service components within the same media stream if the service components are of different routing types.

A further embodiment may incorporate a new layer in the protocol stack architecture to allow service components of the same type to be multiplexed within the same MLC stream. In this embodiment, the mobile device may differentiate service components of the same routing type based on a component ID contained in a header created by the new protocol layer.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a communication system block diagram illustrating a mobile multimedia broadcast communication system suitable for use in an embodiment.

FIG. 2 is an alternative representation of a communication system block diagram of a mobile multimedia broadcast system.

FIG. 3 is a communication and software protocol stack architecture diagram illustrating how the various hardware and software protocol modules interact according to an embodiment.

FIG. 4A is a data schema for a flow record suitable for use with a first embodiment.

FIG. 4B is a data table listing media types that may be associated with different routing type values.

FIGS. 4C and 4D are an illustration of media frames showing the types of information included in the sync layer headers.

FIG. 5 is a process flow diagram of an embodiment method for transmitting multiple service components in a single MLC stream.

FIG. 6 is a process flow diagram of an embodiment method for receiving multiple service components in a single MLC stream.

FIG. 7 is a communication and software protocol stack architecture diagram illustrating how the various hardware and software protocol modules interact according to another embodiment.

FIG. 8A is a data table showing suitable values for components identifier data according to an embodiment.

FIG. 8B is a data schema for a flow record suitable for use with a second embodiment.

FIG. 9 is a process flow diagram of another embodiment method for transmitting multiple service components in a single MLC stream.

FIG. 10 is a process flow diagram of another embodiment method for receiving multiple service components in a single MLC stream.

FIG. 11 is a component block diagram of a mobile device suitable for use in an embodiment.

FIG. 12 is a component block diagram of a server device suitable for use in an embodiment.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

The terms “mobile device” and “receiver device” are used interchangeably herein to refer to any one or all of cellular telephones, personal television devices, personal data assistants (PDA's), palm-top computers, wireless electronic mail receivers (e.g., the Blackberry® and Treo® devices), multimedia Internet enabled cellular telephones (e.g., the Blackberry Storm®), Global Positioning System (GPS) receivers, wireless gaming controllers, and similar personal electronic devices which include a programmable processor and memory and mobile multimedia broadcast receiver circuitry for receiving and processing mobile multimedia broadcast transmissions.

The word “broadcast” is used herein to mean the transmission of data (information packets) so that it can be received by a large number of receiving devices simultaneously. Examples of a broadcast message are mobile television service broadcast signals, including content broadcasts (content flow) and overhead flows.

A number of different mobile broadcast television services and broadcast standards are available or contemplated in the future, all of which may implement and benefit from the various embodiments. Among such services is the MediaFLO® technology that is implemented in FLO TV® by Qualcomm, Incorporated (San Diego, Calif.).

Mobile multimedia broadcast services like MediaFLO® enable mobile receiver devices to be self-contained by broadcasting information about the programs and content that will be broadcast in the future via overhead portions of broadcast transmissions dedicated to carrying information about content flows (referred to herein as an “overhead flow,” “information flow” or “content description flow”), in addition to the broadcast transmissions that carry the content (referred to herein as “content flow”). This information about the content, or “metadata,” enables mobile devices to discover how and when to receive selected content. Mobile devices can also process this metadata to provide users with a program guide, which enables users to select a particular content flow for reception. The program guide enables users to see what programming and content is available, when, and on what “channel” or flow.

A MediaFLO® broadcast network transmits content on a plurality of different “flows,” thereby enabling several different programs to be broadcast simultaneously. MediaFLO® modulates data packets in an orthogonal frequency domain multiplex (OFDM) waveform, carrying the plurality of flows within the same radio frequency band, including the data structures and overhead information that enable receiver devices to select and receive any of the channels or flows. For example, a FLO-based programming lineup that utilizes 30 frames-per-second (fps) QVGA (a Quarter Video Graphics Array or 240×320 pixels) with stereo audio includes 14 real-time streaming video channels of wide-area content (e.g., national content) and 5 real-time streaming video channels of local market-specific content. Individual flows are identified by a flow identifier (flow ID). Information within the content description flow enables receiver devices to determine the particular flow ID to access in order to receive a particular content flow. Content flows will typically include a number of types of data streams, which are referred to as “service components,” including service components carrying video, audio, and sometimes closed captioning. In some cases and implementations, one content flow may include multiple audio streams, such as to provide different language audio programs, and multiple closed captioning streams, such as to support closed captioning in different languages.

Each content flow is carried on one media logical channel (MLC) of the physical layer with the data provided to upper protocol layers which process the data to access a selected content flow and the information flows. MLCs of the physical layer may be carried on one or more sub-carriers of the broadcast signal on certain time slots. In a MediaFLO® broadcast system which uses orthogonal frequency-division multiplexing (OFDM), the broadcast signal may be divided into a large number of orthogonal sub-carriers. OFDM communication technologies and the concept of OFDM sub-carriers are well known in the communication arts.

To provide a power-efficient broadcast system, MediaFLO® receiver devices are organized in terms of an upper layer protocol that works in conjunction with a physical layer protocol. In the upper layer protocol, system information maps content flow (also referred to as media flows) to particular MLCs that are known to the physical layer. Information mapping the flow ID used in the upper layer protocol to particular MLCs may be in the overhead information broadcast by the mobile multimedia broadcast network. Thus, when a user elects to view a particular program and makes the selection on a program guide user interface, the receiver device uses the information received in the overhead flows to determine which MLC(s) to receive and decode.

In order to provide a dynamic and flexible system, broadcasters may dynamically allocate sub-carriers and time slots to MLCs to provide the necessary bandwidth for particular programs and content. Broadcasters then transmit the information mapping sub-carriers and time slots to MLCs in the overhead flows. Since such information is relatively simple and limited, the overhead flows typically consume a minimal portion of the broadcast signal. For example, in MediaFLO, the overhead information service (OIS) is included within the first approximately 10 milliseconds of each one-second superframe.

In a MediaFLO® broadcast network, each MLC can contain up to three streams of data. In practice, one of these streams is limited in data capacity and is therefore used only for carrying overhead information, which leaves two streams for carrying payload data. The media flows of the upper layer protocol are mapped one to one with these physical layer streams. Similarly, a single service component is carried in a single media flow. Therefore, each MLC can only carry two service components. Again, service components include a particular type of service data being broadcast, such as video, audio, and subtitles. Services with more than two components, such as a video with audio and subtitles or video with separate subtitles in different languages, would therefore require use of more than one MLC.

The various embodiments provide methods and systems for transmitting multiple service components in a single MLC stream of a MediaFLO® broadcast transmission, thereby increasing the number of service components that can be carried simultaneously. The embodiments enable a single MLC to carry more service components and allow the media broadcast system to use MLCs efficiently. The benefits of efficiently utilizing the bandwidth in MLC streams includes simplifying MLC allocation to content flows services, and increasing the amount and types of information that may be broadcast within the current broadcast architecture since the total number of MLCs is limited by the available frequency spectrum.

In a first embodiment the transmission and reception of data through MLCs is modified to enable two or more different types of service components to be transmitted at the same time in the same MLC stream. In this embodiment, data packets from the different service components on the same MLC stream are recognized by receiver devices based upon their different routing type information (which is a data field in the data packet header which identifies the type of data—video, audio, text, etc.—included in the packet). This embodiment enables broadcasters to fit multiple service components into the same MLC stream. On the receiving end, a mobile device can separate the data packets from one MLC stream and assign them to the different service components within their corresponding services based upon the flow ID and routing type data included in each packet header. One advantage of this embodiment is that it may be implemented in the existing protocol stack architecture of MediaFLO® by relying on the routing type and flow ID values already included in broadcast data packets. Thus, this embodiment may be implemented within existing broadcast networks and receiver devices, with just a simple software upgrade to add the functionality described in more detail below.

However, the first embodiment only enables multiplexing of different types of data (i.e., different routing types) in the same MLC stream. In some implementations, this limitation may be undesirable, such as when broadcasters wish to transmit multiple languages of either audio or subtitles for the same content flow. For example, it might be desirable to broadcast a single program with Japanese, Chinese, and Korean audio tracks as well as English, Spanish and Thai subtitles. Since the Japanese, Chinese, and Korean audio tracks would have the same routing type (i.e., audio), and the English, Spanish and Thai subtitles would have the same routing type, the first embodiment may require more MLC streams to carry all of this content simultaneously.

An improvement in a second embodiment adds a new logic layer to the MediaFLO® protocol stack to identify different service components that may be included within the same MLC stream based on a component identifier added to the packet header. This embodiment allows service components of the same type to be multiplexed within the same MLC stream. In this embodiment, data packet headers include a component ID field that a component layer in receiver devices can use to properly route service components to their appropriate application. An overhead flow data field may also be used to inform receiver devices when multiple different service components are being broadcast on a particular MLC stream. This embodiment requires a modification to the MediaFLO® architecture to add the service component layer to both broadcaster and receiver device protocol stacks. However, it adds greater flexibility for maximizing the use of the bandwidth available in the broadcast signal without having to increase the number of MLCs.

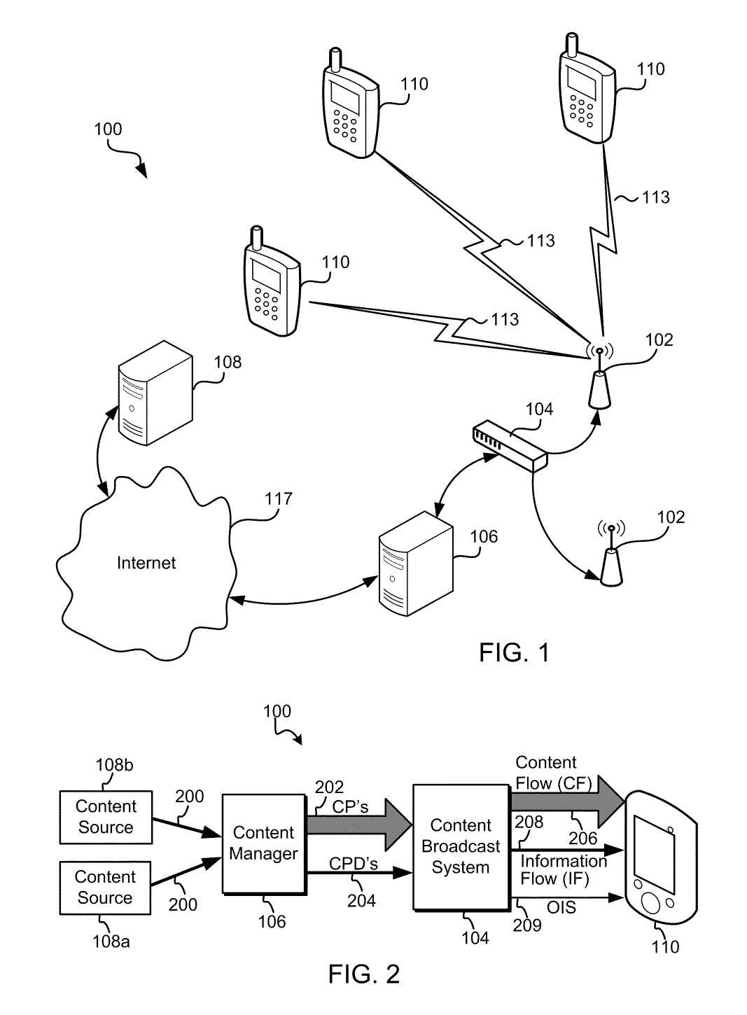

The various embodiments may be implemented within a MediaFLO® broadcast system which is illustrated in FIG. 1. A MediaFLO® broadcast network 100 typically includes a plurality of broadcast transmitters 102 controlled by a broadcast network control center 104 (also known as a broadcast operations center or “BOC”). The MediaFLO® broadcast network 100 broadcasts content from the broadcast transmitters 102 as MediaFLO® transmissions 113 for reception by mobile devices 110. Residing within the broadcast network control center 104 will typically be one or more servers 106 which may be configured to manage the scheduling of content broadcasts, generation of program guides and other metadata and overhead flows related to the content broadcasts, and manage the transmission of the various content and information flows over the mobile multimedia broadcast network 100. One or more servers 106 may also include connections to an external network, such as the Internet 117, through which the server 106 may receive content feeds and other data (e.g., IP data feeds) from content provider servers 108. One or more servers 106 may determine a schedule for broadcast of the content in content flows, generate an information flow including metadata regarding the content flows (e.g., broadcast times and flow IDs), and provide the information flow data to the mobile multimedia broadcast network 100 for inclusion within the broadcast signal that is transmitted for reception by mobile receiver devices 110. The broadcast network control center 104 also includes processors (e.g., a server-based processor) which manage the functions of multiplexing all of the content and overhead flows into the MLCs and the respective MLC streams that constitute the broadcast signal 113.

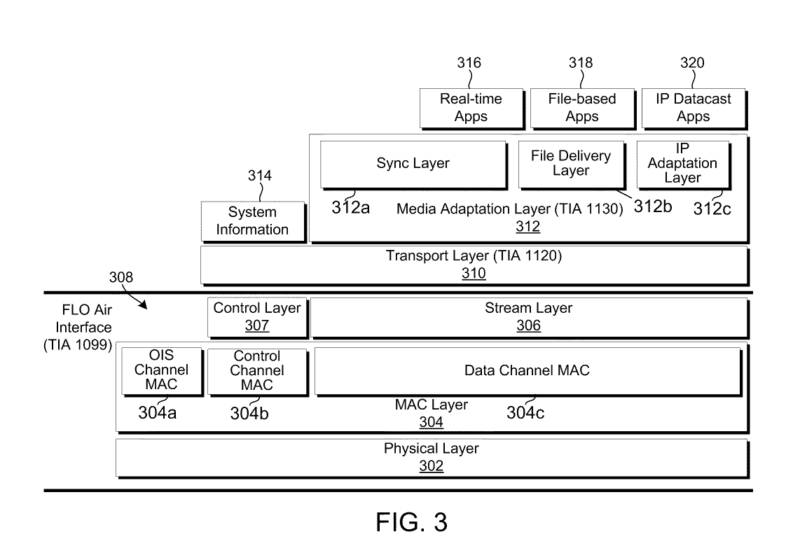

FIG. 2 illustrates the generation and transmission of signals within a mobile multimedia broadcast network 100. As mentioned above, a mobile multimedia broadcast network 100 may receive content (e.g., television programs websites, serial data feeds, etc.) from a number of content sources 108a, 108b. Such content may be provided to a content manager server 106 within a mobile multimedia broadcast network 100 via data networks 200 (e.g., the Internet 117). The content manager server 106 may store such content in a database and schedule the content for broadcast. In scheduling content for broadcast, the content manager server 106 determines what will be broadcast when and on which broadcast stream (e.g., flow or channel number). As part of scheduling, the content manager server 106 may format the content into content packages (CPs) that make up content flows. The content manager server 106 can also determine information about the content, such as a title of the information, its source (e.g., an Internet address, URL or producer), the nature of the information (e.g., sports, news, finance, etc.), its age or date/time of creation, and other information about the content that may be useful for selecting content matching user preferences.

The content manager server 106 may combine the scheduled broadcast time and address with the other information regarding the content (such as the associated MLCs for each content flow) to generate content packet descriptions (CPDs) which will be broadcast in one or more information flows. When content is scheduled for broadcast, the content manager server 106 may provide the content packages to the content broadcast system 104 in an internal network dataflow 202, along with the content package descriptions in an internal network dataflow 204.

The content flows 202 and information flows 204 are processed by the content broadcast system 104 to allocate the data packets to the MLCs and generate the multiplex broadcast waveform which is broadcast by the network transmitters 102 as broadcast transmissions 113.

In order to fit the broadcast content within the available bandwidth, the broadcast system allocates each of the various content flows into MLCs which are defined in the multiplex broadcast signal. In order to enable receiver devices to determine the MLC corresponding to particular content flow numbers, the broadcast signal also includes an overhead information service (OIS) flow of overhead data, as well as other overhead flows, which provides receiver devices with the control information required to receive selected broadcast content flows. The content flows, information flows and OIS are encoded within the multiplex broadcast signal that may include several different content flows (CF) 206 which are data packets carrying the broadcast content, one or more information flows (IF) 208 which include data packets carrying the content packet descriptions, and the OIS flow 209 which provides information that the receiver device needs to receive the content and information flows 206, 208. Receiver devices 110 receive the broadcast transmissions and are able to separately process content flow 206 and the content description flow 208 using the information provided in the OIS 209 and other overhead flows.

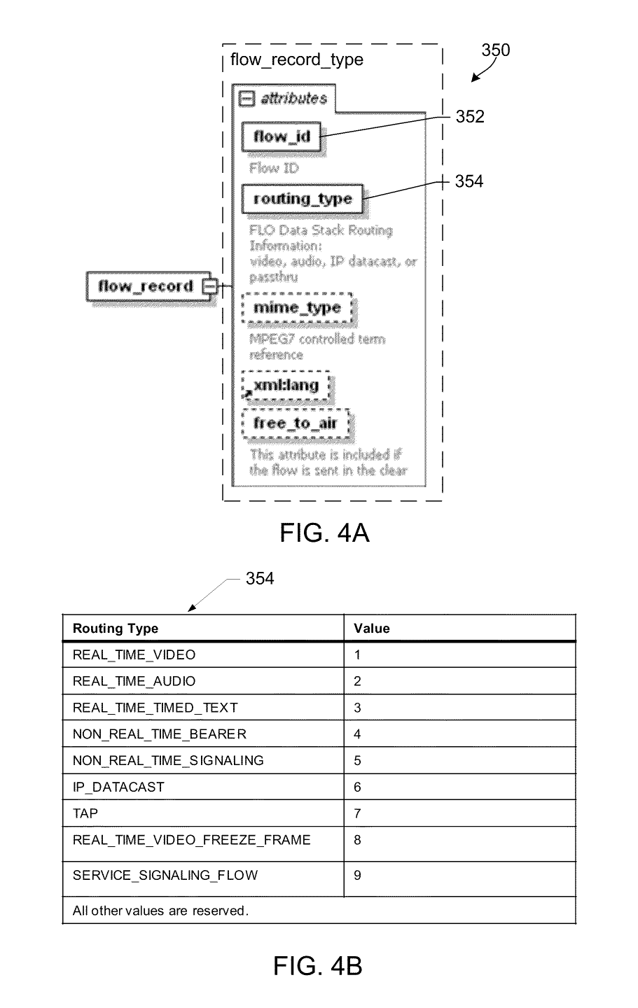

FIG. 3 is a protocol stack diagram illustrating the interactions of the various hardware and software protocol modules within a MediaFLO® mobile broadcast receiver device. A MediaFLO® receiver will include a FLO air interface 308 which includes hardware and software modules defined by the Telecommunication Industry Association specification TIA 1099. The FLO air interface includes a physical layer 302 of radio components that receive the basic signal and provide the received data to a media access control layer (MAC layer) data communication protocol sub-layer 304. The MAC layer provides addressing and channel access control mechanisms that make it possible for various components of the receiver to receive the different streams of data encoded in the broadcast signal. The MAC layer may be implemented in hardware, in software, or in a combination of hardware and software which may be referred to as a medium access controller. The MAC layer may include an OIS Channel MAC 304a, a Control Channel MAC 304b, and a Data Channel MAC 304c.

The portions of the broadcast signal carrying the content and information flows may be passed by the MAC layer 304 to a stream layer 306 which is the data interface to the transport layer 310 (which is defined by TIA 1120) in the receiver device. The FLO air interface 308 may also include a control layer 307 for controlling the various operations of the air interface. Broadcast data received in the transport layer 310 may be processed by a media adaptation layer 312 (defined by TIA 1130) which functions to deliver data packets to the appropriate upper layer modules that can make use of the data, such as the system information module 314, real-time applications 316, file-based applications 318, and IP data cast applications 320.

FIG. 3 further shows that the media adaptation layer 312 may include a synchronization (“sync”) layer 312a, a file delivery layer 312b, and an IP adaptation layer 312c. The synchronization (“sync”) layer 312a may provide synchronization adaptation functionality to enable real-time applications 316 to receive and process real-time content from the transport layer 310 and the FLO Air Interface 308. The file delivery layer 312b may include file management and adaptation functionality to enable file-based applications 318 to receive non-real-time files from the transport layer 310 and the FLO Air Interface 308. The IP adaptation layer 312c provides packet encapsulation or recovery to enable IP applications, such as IP datacast applications 320, to process IP data received from the transport layer 310 and the FLO Air Interface 308.

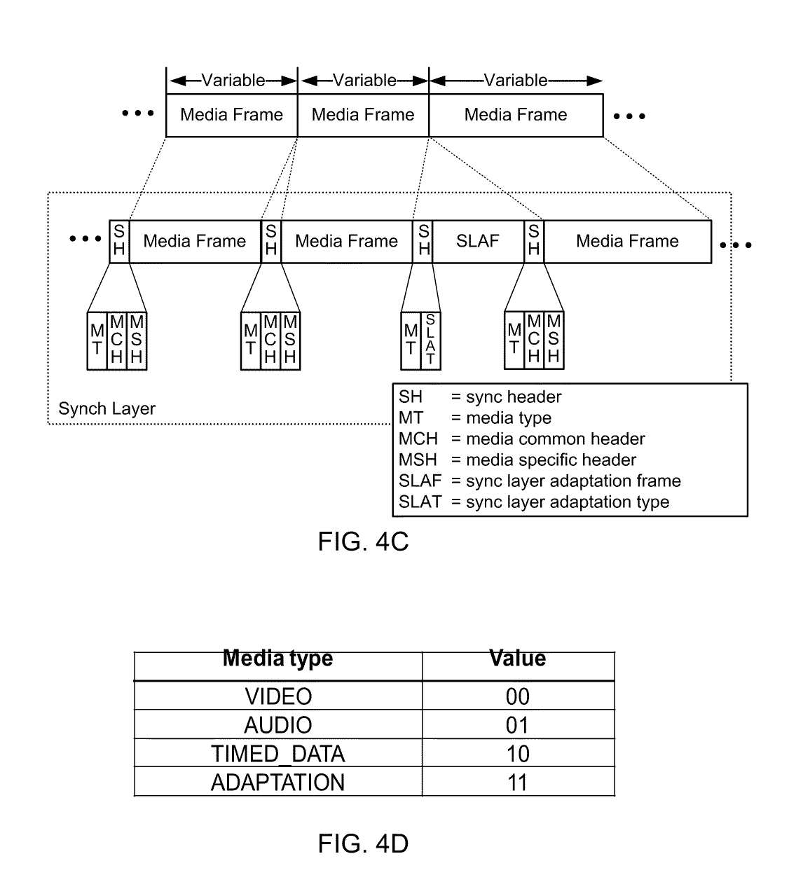

As mentioned above, in a first embodiment, the routing type field is used to enable differentiating of different service components within a single MLC stream by imposing the requirement that only service components of different routing types can be included in the same MLC stream. Thus, in this embodiment, data packets belonging to different service components sharing one MLC stream will be of different media types. As illustrated in FIG. 4A, the attributes of a flow record 350 include a flow ID 352 and the routing type 354. As illustrated in the table shown in FIG. 4B, a variety of different types of data can be identified by the routing type 354. This information is included in the MediaFLO system information, and is also incorporated into the packet headers. The routing type 354 in the system information record is included in the sync layer header information as media type (MT) information, as illustrated in FIG. 4C. The media type may be indicated by a two bit value included in this layer header as illustrated in FIG. 4D.

As FIG. 4C illustrates, a receiver device reading packets in the sync layer can quickly recognize each packet per frame based upon the media type (MT) value in the sync header (SH). Since the media type information is already inserted in the sync header based upon the routing type value in the flow record system information, implementing this embodiment requires no changes to the data structures and header information.

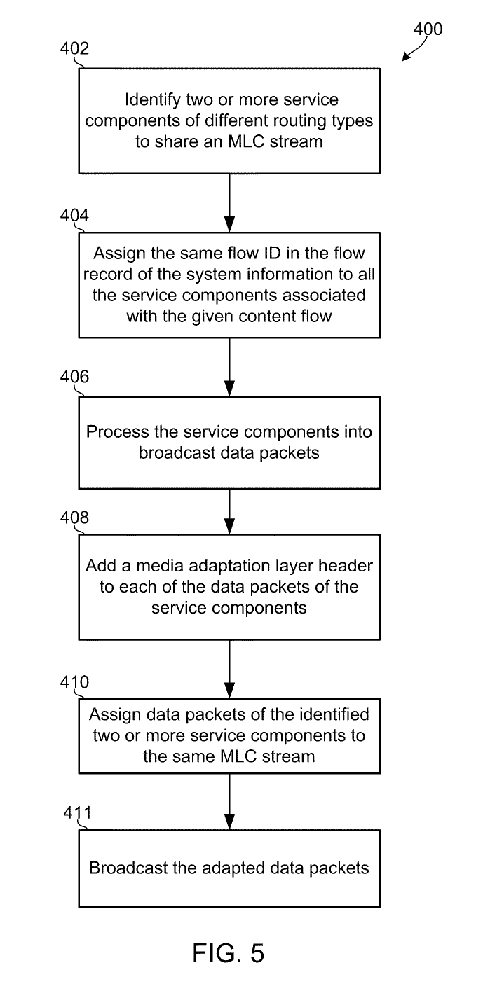

An example embodiment method 400 for multiplexing several service components into a single media flow from the broadcast end is illustrated in FIG. 5. In step 402, two or more different service components may be identified by the broadcast network control center to be carried over the same MLC stream. The service components selected to share a common MLC stream may be selected based on their respective routing types (i.e., type of media), as well as upon the relative bandwidth required to carry each of the service components, so as to maximize the carrying capacity of each MLC stream. In this embodiment method 400, the service components identified to share a common MLC stream must be of different routing types. If two service components of the same routing type and the same flow ID are broadcast on the same MLC stream, the receiver would not be able to differentiate between the two service components.

In step 404, the service components carried over the same MLC stream are logically grouped into a content flow and assigned the same flow ID in the flow record of the system information.

The identified service components are then processed in the normal manner for broadcast, including dividing the service component data into many discrete data packets in step 406. These data packets may be combined with a media adaptation layer header in step 408. The data packets' media adaptation layer header includes the flow ID, a media type field (which specifies the type of data included in the packet based upon the system information routing type), a media common header, and a media specific header. Media adaptation layer headers include sync layer headers (illustrated in FIG. 4C), file delivery layer headers, and IP adaptation layer headers. These layer headers provide the mobile device receiver and processor circuitry with the information needed to properly route packets to their intended upper level application layer destination.

With the data packets assembled, data packets from the selected two or more service components of different routing types may be assembled into the same MLC stream in step 410, and broadcast in step 411.

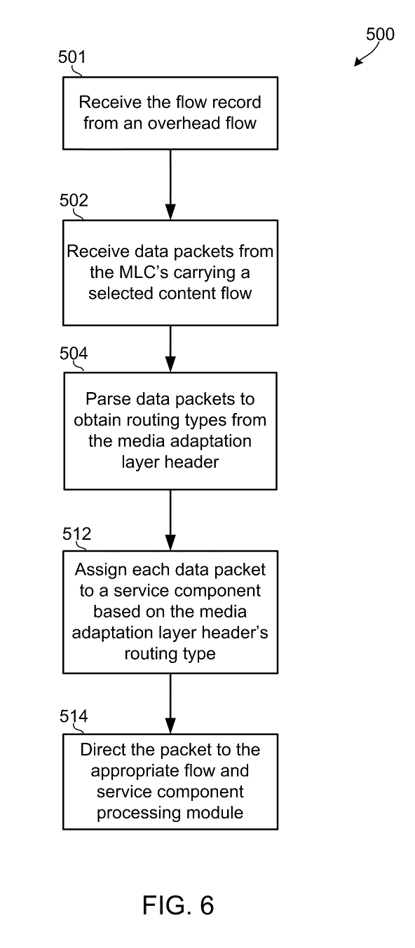

An embodiment method 500 for processing data packets received from MLC streams which have been multiplexed as described above is illustrated in FIG. 6. In step 501, the device receiver and processor receives the flow record received from an overhead flow. This information enables the receiver device to correlate the routing type in the flow record with the media type in the media adaptation layer header of the data packet in order to the multiplex different service components broadcast within the same MLC stream. A receiver circuit within the mobile device 110 may receive the data packets associated with a selected content or program from the MLC streams carrying the selected service components in a content flow in step 502. In this step, those data packets included in MLC streams carrying a selected service component are received, while other data packets may be ignored. In step 504, a processor of the receiver device may parse the received data packets to obtain their media type value in the sync layer header. The processor may use each data packet's media type value to assign the packet to the corresponding service component (i.e., video, audio, timed data or adaptation) in step 512. The data packets can then be directed to the assigned service component processing module (i.e., the processing module for the media type listed in the sync layer head) for processing in step 514.

While receiver devices may detect the presence of multiplexed service components on an MLC stream by detecting different media type values in the packet headers, information may be included in MediaFLO® system information to alert mobile devices that certain MLC streams are multiplexed. In this embodiment, mobile devices may not test the media type value of all data packets unless the received system information indicates that a particular MLC is multiplexed.

The embodiments described above with reference to FIGS. 3-6 enables improved utilization of bandwidth without requiring any changes to the MediaFLO® architecture. This ability to increase bandwidth utilization without requiring a change to broadcaster or receiver device hardware is attractive for existing markets. However, the limitation that data packets multiplexed on the same MLC stream must have different media types may impose undesirable system limitations particularly in implementations where there may be a desire to carry multiple service components of the same media type (e.g., different language audio streams or closed captioning for multiple languages).

Another embodiment can overcome the restriction on media types of multiplexed service components by adding a new architecture layer for handling service components according to a service component header added to the data packets. In this embodiment, the service component header information can enable multiple different service components of the same media type to be broadcast on the same MLC stream and properly routed to the appropriate service component processing module in receiver devices.

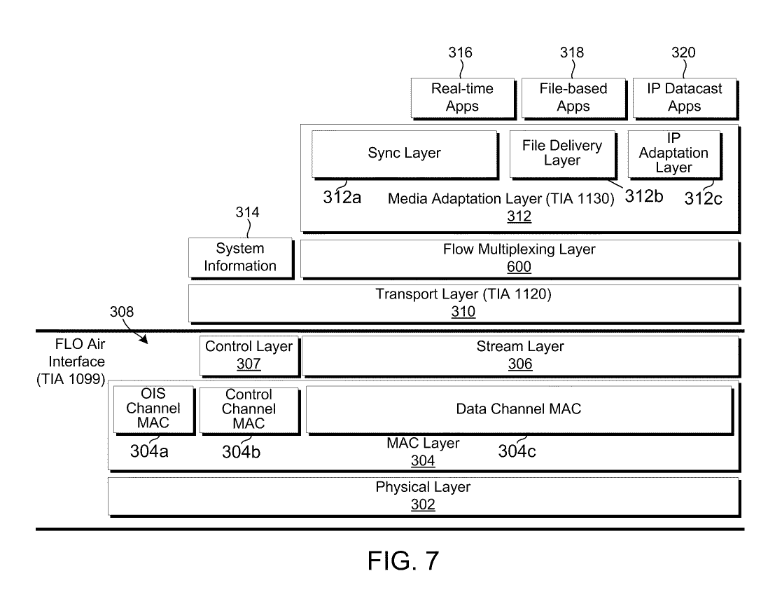

A protocol stack diagram of this embodiment is illustrated in FIG. 7. As noted above, if two service components of the same routing type are included in the same MLC stream, the receiver would not be able to differentiate between the two without some additional data or protocol. This embodiment provides such additional data and a processing layer configured to differentiate between service components of the same media or routing type. In the receiver device in this embodiment a Flow Multiplexing Layer 600 is added to the software architecture. This processing layer obtains the information in a component layer header and insures proper routing of the data packets based upon that information. To accomplish this, the flow multiplexing layer 600 may use information included in an overhead flow which correlates different component IDs within the component header to particular service components. Using this information, the flow multiplexing layer 600 can identify data packets for service components being received based upon their component ID and route the data packets accordingly. Other than the addition of the flow multiplexing layer 600, FIG. 7 is substantially the same as the software architecture illustrated in FIG. 3.

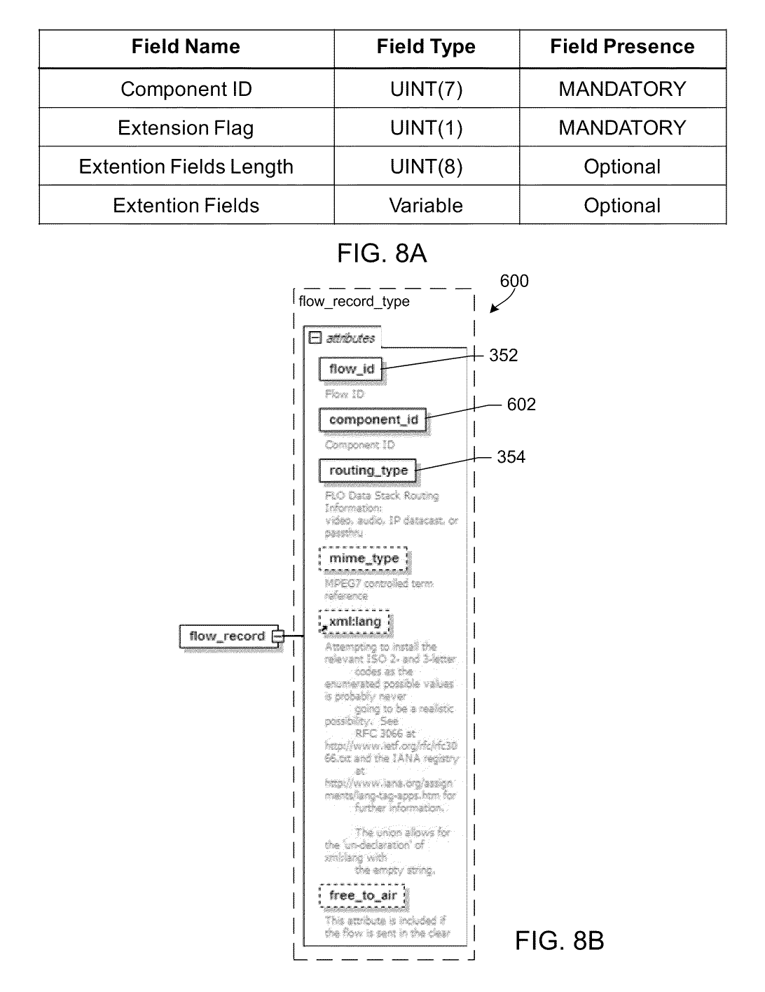

Example characteristics for the component identifier within the component packet header are illustrated in FIG. 8A. In an embodiment, the component packet header may include a component identifier field and an extension flag. In the embodiment illustrated in FIG. 8A, the component ID is a seven bit integer value while the extension flag is a single bit. Thus, the component packet header may be only one byte in length. If the extension flag is set, the component header may optionally also include extension fields of variable length along with extension field length information to enable the receiver device to accurately parse out the extension fields.

Component information may be included in the system information as illustrated in the data schema 600 illustrated in FIG. 8B. As illustrated, this embodiment may be accomplished by adding a component identifier attribute 602 to each flow record. Thus the basic elements of the flow record may include the flow ID 352, the component ID 602 and the routing type 354.

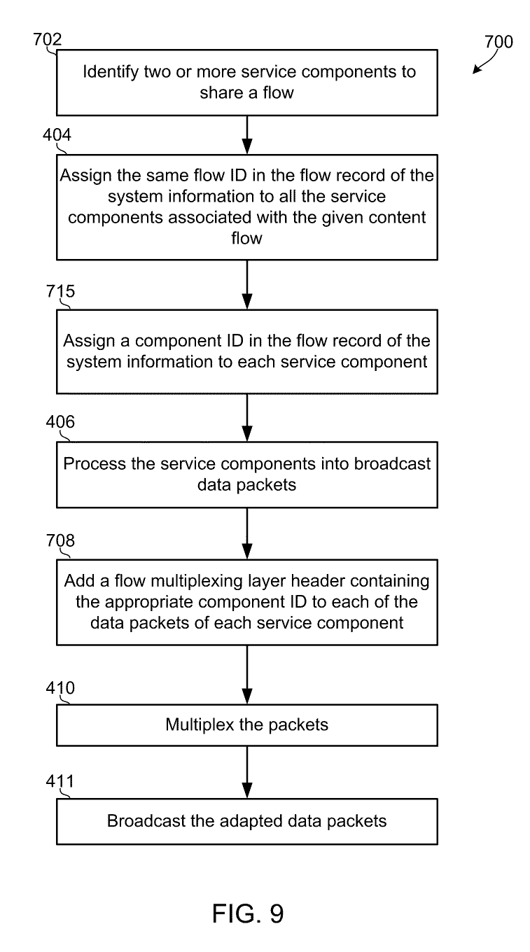

An example method 700 for broadcasting multiple service components within a single MLC stream according to the another embodiment is illustrated in FIG. 9. In method 700, two or more service components may be identified to broadcast over the same MLC stream in step 702. In this embodiment, the identified service components may be of the same media or routing type. In step 404, the service components sharing the same MLC stream are assigned the same flow ID with this information included in the flow record of the system information. In step 715, the identified service components are assigned component IDs distinguishing the respective service components, with the assign component IDs included in the MediaFLO® system information. This MediaFLO® system information can be used to signal the different service components sharing the same MLC stream. This component ID may be unique to each service component or at least unique to each of the identified service components to be multiplexed in the same MLC stream.

The identified service components are then processed for broadcast, including dividing the service component data into many discrete data packets in step 406. These data packets may be combined with a flow multiplexing layer header in step 708. The flow multiplexing layer header can include the component ID assigned to the data packet's service component or an equivalent data element. The data packets are then multiplexed in step 410, and broadcast in step 411.

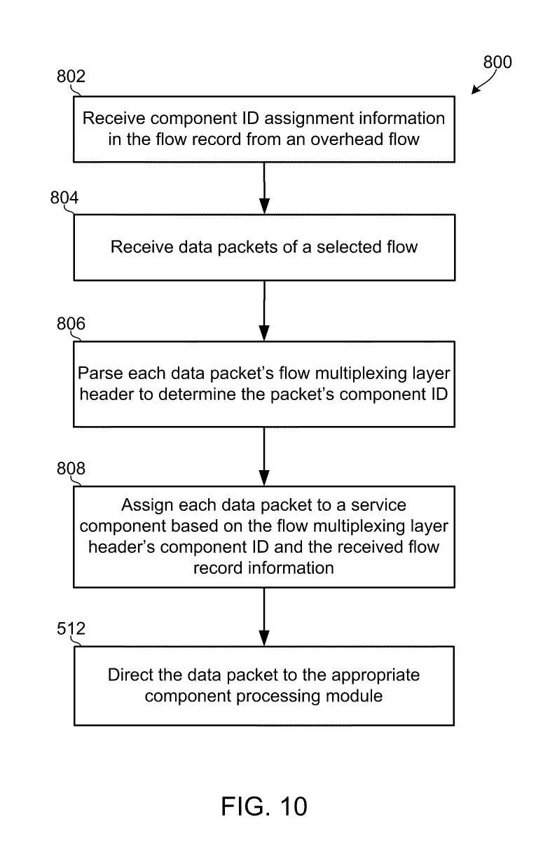

An embodiment method 800 for processing data packets received from MLC streams which have been multiplexed and labeled with a component header as described above is illustrated FIG. 10. In step 802, the device receiver and processor receives component ID assignment information in the flow record received from an overhead flow. This information enables the receiver device to correlate the component ID in the flow record with the component ID in the flow multiplexing header of the data packet in order to multiplex different service components broadcast within the same MLC stream. A receiver circuit within a mobile device, such as the mobile device 110, may receive the data packets in step 804. In this step, those data packets including in MLC streams carrying a selected flow are received, while other data packets may be ignored. In step 806, a processor within the mobile device may parse the multiplexing layer header of each received data packet flow to obtain the data packet's component ID value. In step 808, the processor may assign each data packet to a corresponding service component based upon the component ID in the flow multiplexing layer header based on the information included in the system information received in step 804. In step 512, the processor then directs each data packet to the appropriate component processing module.

The processing of received data packets in a mobile device may be performed by a receiver circuit coupled to a processor or in a receiver circuit that includes processor logic configured to perform the operations described above with reference to FIGS. 6 and 10. Thus, references to a single processor performing the operations described above are not intended to limit the scope of the claims to any particular circuit architecture.

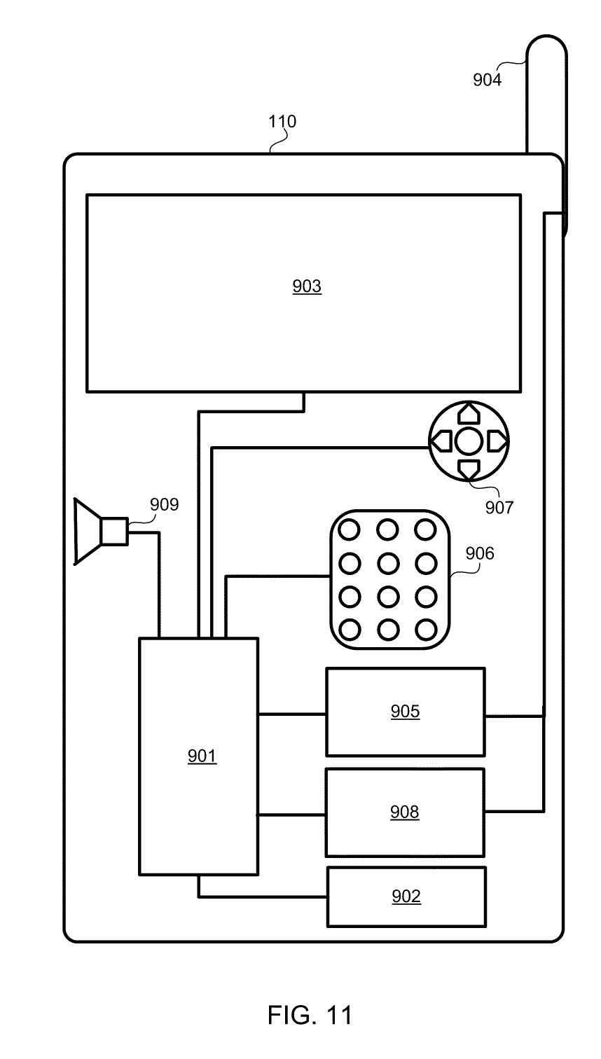

Typical mobile devices 110 suitable for use with the various embodiments will likely have in common the components illustrated in FIG. 11. For example, an exemplary mobile receiver device 110 may include a processor 901 coupled to internal memory 902, a display 903, and to a speaker 909. Additionally, the mobile device 110 may have an antenna 904 for sending and receiving electromagnetic radiation that is connected to a wireless data link and a cellular telephone transceiver 905 coupled to the processor 901, and a MediaFLO® mobile multimedia broadcast receiver 908 coupled to the processor 901. Mobile devices typically also include a key pad 906 or miniature keyboard and menu selection buttons or rocker switches 907 for receiving user inputs.

The processor 901 may be any programmable microprocessor, microcomputer or multiple processor chip or chips that can be configured by software instructions (e.g., applications) to perform a variety of functions, including the functions of the various embodiments described herein. In some mobile devices, multiple processors 901 may be provided, such as one processor dedicated to wireless communication functions and one processor dedicated to running other applications. In some mobile devices, the various embodiments operations described above may be performed by a processor that is included within the MediaFLO® mobile multimedia broadcast receiver 908. Typically, software applications may be stored in the internal memory 902 before they are accessed and loaded into the processor 901. In some mobile devices, the processor 901 may include internal memory sufficient to store the application software instructions. In some mobile devices, the secure memory may be in a separate memory chip coupled to the processor 901. In many mobile devices 110, the internal memory 902 may be a volatile or nonvolatile memory, such as flash memory, or a mixture of both. For the purposes of this description, a general reference to memory refers to all memory accessible by the processor 901, including internal memory 902, removable memory plugged into the mobile device, and memory within the processor 901 itself.

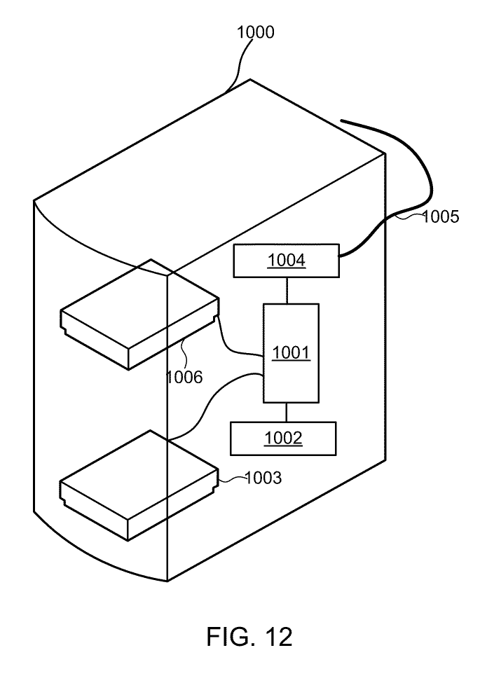

A number of the embodiments described above may also be implemented with any of a variety of commercially available remote server devices, such as the server 1000 illustrated in FIG. 12. Such a server 1000 typically includes a processor 1001 coupled to volatile memory 1002 and a large capacity nonvolatile memory, such as a disk drive 1003. The server 1000 may also include a floppy disc drive and/or a compact disc (CD) drive 1006 coupled to the processor 1001. The server 1000 may also include network access ports 1004 coupled to the processor 1001 for establishing data connections with a network 1005, such as the Internet.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc., are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary embodiments, the functions described may be implemented in hardware, software, firmware, or any combination thereof If implemented in software, the functions may be stored on as one or more instructions or code on a tangible processor-readable storage medium. The steps of a method or algorithm disclosed herein may be embodied in a processor-executable software module executed which may reside on a tangible, non-transitory processor-readable storage medium. A tangible, non-transitory processor-readable storage medium may be any available storage media that may be accessed by a computer. By way of example, and not limitation, such tangible, non-transitory processor-readable storage media may comprise RAM, ROM, EEPROM, CD-ROM or other optical disk storage, magnetic disk storage or other magnetic storage devices, or any other tangible storage medium that may be used to carry or store desired program code in the form of instructions or data structures and that may be accessed by a processor. Optical disk storage includes compact disc (CD), laser disc, optical disc, digital versatile disc (DVD), and blu-ray disc. Combinations of the above should also be included within the scope of tangible, non-transitory processor-readable storage media. Additionally, the operations of a method or algorithm residing as one or any combination or set of codes and/or instructions on a tangible, non-transitory processor-readable storage medium may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method of multiplexing multiple service components in a single mediaFLO logical channel (MLC) stream within a MediaFLO® broadcast signal, comprising:
selecting service components of different media types for multiplexing over a single MLC stream;
broadcasting data packets of the selected service components in the same MLC stream;
receiving the data packets from the MLC stream;
parsing a sync layer header of the received data packets to obtain their media type values; and
routing each data packet from the MLC stream to a service component corresponding to the obtained media type value.

2. The method of claim 1, further comprising:
including within a broadcast overhead flow information indicating that the MLC stream is carrying multiplexed service component data packets; and
receiving the information indicating that the MLC stream is carrying multiplexed service component data packets from the broadcast overhead flow.

3. The method of claim 2, wherein parsing a sync layer header of the received data packets to obtain their media type values is performed only when the received broadcast overhead flow includes information indicating that the MLC stream is carrying multiplexed service component data packets.

4. A method of multiplexing multiple service components in a single mediaFLO logical channel (MLC) stream within a MediaFLO® broadcast signal, comprising:
selecting service components for multiplexing over a single MLC stream;
assigning a different component identifier to each of the selected service components;
including information regarding the assigned component identifiers in a broadcast overhead flow;
including in a component layer header in each data packet the component identifier assigned to the service component to which the data packet relates;
broadcasting data packets of the selected service components in the same MLC stream;
receiving the information regarding the assigned component identifiers from the broadcast overhead flow;
receiving the data packets from the MLC stream;
parsing the received data packets to obtain a component ID value from a component header; and
selecting data packets for processing and routing selected data packets to appropriate service component processing modules based upon the obtained component ID value and the received information regarding the assigned component identifiers.

5. A wireless communication system, comprising:
a multimedia broadcast network, comprising:
a server; and
a broadcast transmitter system coupled to the server,
wherein the server is configured with server-executable instructions to format content for broadcast and to direct the broadcast transmitter system to:
select service components of different media types for multiplexing over a single MLC stream; and
broadcast data packets of the selected service components in the same MLC stream; and
a mobile device, comprising:
a processor;
a receiver circuit coupled to the processor and configured to receive multimedia broadcasts; and
a memory coupled to the processor,
wherein the processor is configured with processor-executable instructions to perform operations comprising:
receiving the data packets from the MLC stream via the receiver circuit;
parsing a sync layer header of the received data packets to obtain their media type values; and
routing each data packet from the MLC stream to a service component corresponding to the obtained media type value.

6. The wireless communication system of claim 5, wherein:
the server is configured with further server-executable instructions to include within a broadcast overhead flow information indicating that the MLC stream is carrying multiplexed service component data packets; and
the processor is configured with processor-executable instructions to perform operations further comprising receiving the information indicating that the MLC stream is carrying multiplexed service component data packets from the broadcast overhead flow

7. The wireless communication system of claim 6, wherein:
the processor is configured with processor-executable instructions to perform operations such that parsing a sync layer header of the received data packets to obtain their media type values is performed only when the received broadcast overhead flow includes information indicating that the MLC stream is carrying multiplexed service component data packets.

8. A wireless communication system, comprising:
a multimedia broadcast network, comprising:
means for selecting service components of different media types for multiplexing over a single MLC stream; and
means for broadcasting data packets of the selected service components in the same MLC stream; and
a mobile device, comprising:
means for receiving the data packets from the MLC stream;
means for parsing a sync layer header of the received data packets to obtain their media type values; and
means for routing each data packet from the MLC stream to a service component corresponding to the obtained media type value.

9. The wireless communication system of claim 8, wherein:
the multimedia broadcast network further comprises means for including within a broadcast overhead flow information indicating that the MLC stream is carrying multiplexed service component data packets; and
the mobile device further comprises means for receiving the information indicating that the MLC stream is carrying multiplexed service component data packets from the broadcast overhead flow.

10. The wireless communication system of claim 9, wherein means for parsing a sync layer header of the received data packets to obtain their media type values comprises means for parsing a sync layer header of the received data packets to obtain their media type values only when the received broadcast overhead flow includes information indicating that the MLC stream is carrying multiplexed service component data packets.

11. A wireless communication system, comprising:
a multimedia broadcast network, comprising:
a server; and
a broadcast transmitter system coupled to the server,
wherein the server is configured with server-executable instructions to format content for broadcast and to direct the broadcast transmitter system to:
select service components for multiplexing over a single MLC stream;
assign a different component identifier to each of the selected service components;
include information regarding the assigned component identifiers in a broadcast overhead flow;
include in a component layer header in each data packet the component identifier assigned to the service component to which the data packet relates; and
broadcast data packets of the selected service components in the same MLC stream; and
a mobile device, comprising:
a processor;
a receiver circuit coupled to the processor and configured to receive multimedia broadcasts; and
a memory coupled to the processor,
wherein the processor is configured with processor-executable instructions to perform operations comprising:
receiving the information regarding the assigned component identifiers from the broadcast overhead flow;
receiving the data packets from the MLC stream;
parsing the received data packets to obtain a component ID value from a component header; and
selecting data packets for processing and routing selected data packets to appropriate service component processing modules based upon the obtained component ID value and the received information regarding the assigned component identifiers.

12. A wireless communication system, comprising:
a multimedia broadcast network, comprising:
means for selecting service components for multiplexing over a single MLC stream;
means for assigning a different component identifier to each of the selected service components;
means including information regarding the assigned component identifiers in a broadcast overhead flow;
means for including in a component layer header in each data packet the component identifier assigned to the service component to which the data packet relates; and
means for broadcasting data packets of the selected service components in the same MLC stream; and
a mobile device, comprising:
means for receiving the information regarding the assigned component identifiers from the broadcast overhead flow;
means for receiving the data packets from the MLC stream;
means for parsing the received data packets to obtain a component ID value from a component header; and
means for selecting data packets for processing and routing selected data packets to appropriate service component processing modules based upon the obtained component ID value and the received information regarding the assigned component identifiers.

13. A multimedia broadcast network, comprising:
a server; and
a broadcast transmitter system coupled to the server,
wherein the server is configured with server-executable instructions to format content for broadcast and to direct the broadcast transmitter system to:
select service components of different media types for multiplexing over a single MLC stream; and
broadcast data packets of the selected service components in the same MLC stream.

14. The multimedia broadcast network of claim 13, wherein the server is further configured with server-executable instructions to include within a broadcast overhead flow information indicating that the MLC stream is carrying multiplexed service component data packets.

15. A multimedia broadcast network, comprising:
means for selecting service components of different media types for multiplexing over a single MLC stream; and
means for broadcasting data packets of the selected service components in the same MLC stream.

16. The multimedia broadcast network of claim 15, further comprising:
means for including within a broadcast overhead flow information indicating that the MLC stream is carrying multiplexed service component data packets.

17. A tangible non-transitory server-readable storage medium having stored thereon server-executable instructions configured to cause a server of a multimedia broadcast network to perform operations comprising:
selecting service components of different media types for multiplexing over a single MLC stream; and
broadcasting data packets of the selected service components in the same MLC stream.

18. The tangible non-transitory server-readable storage medium of claim 17, wherein the stored server-executable instructions are configured to cause a server of a multimedia broadcast network to perform operations further comprising:
including within a broadcast overhead flow information indicating that the MLC stream is carrying multiplexed service component data packets.

19. A multimedia broadcast network, comprising:
a server; and
a broadcast transmitter system coupled to the server,
wherein the server is configured with server-executable instructions to format content for broadcast and to direct the broadcast transmitter system to:
select service components for multiplexing over a single MLC stream;
assign a different component identifier to each of the selected service components;
include information regarding the assigned component identifiers in a broadcast overhead flow;
include in a component layer header in each data packet the component identifier assigned to the service component to which the data packet relates; and
broadcast data packets of the selected service components in the same MLC stream.

20. A multimedia broadcast network, comprising:
means for selecting service components for multiplexing over a single MLC stream;
means for assigning a different component identifier to each of the selected service components;
means including information regarding the assigned component identifiers in a broadcast overhead flow;
means for including in a component layer header in each data packet the component identifier assigned to the service component to which the data packet relates; and
means for broadcasting data packets of the selected service components in the same MLC stream.

21. A tangible non-transitory server-readable storage medium having stored thereon server-executable instructions configured to cause a server of a multimedia broadcast network to perform operations comprising:
selecting service components for multiplexing over a single MLC stream;
assigning a different component identifier to each of the selected service components;
including information regarding the assigned component identifiers in a broadcast overhead flow;
including in a component layer header in each data packet the component identifier assigned to the service component to which the data packet relates; and
broadcasting data packets of the selected service components in the same MLC stream.

22. A mobile device, comprising:
a processor;
a receiver circuit coupled to the processor and configured to receive multimedia broadcasts; and
a memory coupled to the processor,
wherein the processor is configured with processor-executable instructions to perform operations comprising:
receiving data packets from an MLC stream via the receiver circuit;
parsing a sync layer header of the received data packets to obtain their media type values; and
routing each data packet from the MLC stream to a service component corresponding to the obtained media type value.

23. The mobile device of claim 22, wherein the processor is configured with processor-executable instructions to perform operations further comprising receiving information indicating that the MLC stream is carrying multiplexed service component data packets from a broadcast overhead flow.

24. The mobile device of claim 23, wherein parsing a sync layer header of the received data packets to obtain their media type values is performed only when the received broadcast overhead flow includes information indicating that the MLC stream is carrying multiplexed service component data packets.

25. A mobile device, comprising:
means for receiving data packets from an MLC stream;
means for parsing a sync layer header of the received data packets to obtain their media type values; and
means for routing each data packet from the MLC stream to a service component corresponding to the obtained media type value.

26. The mobile device of claim 25, further comprising means for receiving information indicating that the MLC stream is carrying multiplexed service component data packets from a broadcast overhead flow.

27. The mobile device of claim 26, wherein means for parsing a sync layer header of the received data packets to obtain their media type values comprises means for parsing a sync layer header of the received data packets to obtain their media type values only when the received broadcast overhead flow includes information indicating that the MLC stream is carrying multiplexed service component data packets.

28. A tangible non-transitory processor-readable storage medium having stored thereon processor-executable instructions configured to cause a processor of a mobile device to perform operations comprising:
receiving data packets from an MLC stream;
parsing a sync layer header of the received data packets to obtain their media type values; and
routing each data packet from the MLC stream to a service component corresponding to the obtained media type value.

29. The tangible non-transitory processor-readable storage medium of claim 28, wherein the stored processor-executable instructions are configured to cause a processor of a mobile device to perform operations further comprising receiving information indicating that the MLC stream is carrying multiplexed service component data packets from a broadcast overhead flow.

30. The tangible non-transitory processor-readable storage medium of claim 29, wherein the stored processor-executable instructions are configured to cause a processor of a mobile device to perform operations such that parsing a sync layer header of the received data packets to obtain their media type values is performed only when the received broadcast overhead flow includes information indicating that the MLC stream is carrying multiplexed service component data packets.

31. A mobile device, comprising:
a processor;
a receiver circuit coupled to the processor and configured to receive multimedia broadcasts; and
a memory coupled to the processor,
wherein the processor is configured with processor-executable instructions to perform operations comprising:
receiving information regarding assigned component identifiers from a broadcast overhead flow;
receiving data packets from an MLC stream via the receiver circuit;
parsing the received data packets to obtain a component ID value from a component header; and
selecting data packets for processing and routing selected data packets to appropriate service component processing modules based upon the obtained component ID value and the received information regarding the assigned component identifiers.

32. A mobile device, comprising:
means for receiving information regarding assigned component identifiers from a broadcast overhead flow;
means for receiving data packets from an MLC stream;
means for parsing the received data packets to obtain a component ID value from a component header; and
means for selecting data packets for processing and routing selected data packets to appropriate service component processing modules based upon the obtained component ID value and the received information regarding the assigned component identifiers.

33. A tangible non-transitory processor-readable storage medium having stored thereon processor-executable instructions configured to cause a processor of a mobile device to perform operations comprising:
receiving information regarding assigned component identifiers from a broadcast overhead flow;
receiving data packets from an MLC stream;
parsing the received data packets to obtain a component ID value from a component header; and
selecting data packets for processing and routing selected data packets to appropriate service component processing modules based upon the obtained component ID value and the received information regarding the assigned component identifiers.
